(19) United States
(12) Patent Application Publication
(10) Pub. No.: US 2026/0091820 A1
(43) Pub. Date: Apr. 2, 2026

(54) Folding Stroller

(71) Applicant: NINGBO BEICHI BABY PRODUCTS CO., LTD., Ningbo (CN)

(72) Inventor: Fangliang Weng, Ningbo (CN)

(21) Appl. No.: 19/342,667

(22) Filed: Sep. 29, 2025

(30) Foreign Application Priority Data
Sep. 30, 2024 (CN) 202422411323.1
Apr. 30, 2025 (CN) 202520866951.0
Sep. 1, 2025 (CN) 202521876900.2

(51) Int. Cl. B62B 7/08; B62B 9/10; B62B 9/24

(52) U.S. Cl. CPC B62B 7/08; B62B 9/108; B62B 9/24; B62B 2205/06

(57) ABSTRACT

Provided is a folding stroller, which relates to the field of strollers. The folding stroller includes a chassis and end frames. The chassis includes a first support rod and a second support rod, and a first support frame and a second support frame. A coaxially connected reinforcing arm is provided at a rotating shaft of the first support rod and the second support rod; the reinforcing arm has one end fixed on the first support frame; the second support rod has one end rotatably connected to both the first support rod and the reinforcing arm, and the second support rod is located between the first support rod and the reinforcing arm. The present application has an effect of increasing the connection strength at the folding joint of the chassis.

### CROSS REFERENCE TO RELATED APPLICATIONS

The present claims the benefit of Chinese Patent Application Nos. 202521876900.2 filed on Sep. 1, 2025, 202520866951.0 filed on Apr. 30, 2025 and 202422411323.1 filed on Sep. 30, 2024. All the above are hereby incorporated by reference in their entirety.

### TECHNICAL FIELD

The present application relates to the field of strollers, and in particular relates to a folding stroller.

### BACKGROUND ART

In recent years, family outdoor activities have gradually become more popular, especially travel and outdoor camping. During outdoor activities, people usually carry many items, and families with children generally also carry child strollers; the folding strollers have made people's travel more convenient. The folding stroller can not only hold items but also be used for the children to ride.

Existing folding strollers generally include a frame, a chassis, wheels, and handles; the frame and the chassis are usually rectangular frame structures and are connected with a folding structure; the frame is equipped with a cloth cover for placing items, and the chassis is used for supporting the cloth cover. However, in the prior art, the folding joint of the chassis often has a problem of insufficient connection strength, and when heavy items are placed or children ride on it, the chassis is prone to deformation.

### SUMMARY OF THE INVENTION

To increase the connection strength of the folding joint of the chassis, the present application provides a folding stroller.

The folding stroller provided by the present application adopts the following technical solution:
a folding stroller including a chassis and end frames located at two ends of the chassis, the two end frames being a first end frame and a second end frame respectively, where the chassis includes:
a first support rod provided in two, each having one end rotatably connected to the first end frame;
a second support rod provided in two, each having one end rotatably connected to the second end frame;
a first support frame fixed between the two first support rods;
a second support frame fixed between the two second support rods; and
a reinforcing arm having one end fixed on the first support frame, the second support rod having one end rotatably connected to both the first support rod and the reinforcing arm, a rotation joint between the second support rod and the reinforcing arm being coaxial with a rotation joint between the second support rod and the first support rod, and the second support rod being located between the first support rod and the reinforcing arm.

By using the above technical solution, the reinforcing arm is fixed on the first support frame and fixedly connected to the first support rod, the second support rod has one end rotatably connected to both the first support rod and the reinforcing arm, the folding joint between the second support rod and the reinforcing arm is coaxial with the folding joint between the second support rod and the first support rod, and when downward pressure is applied at the rotating shaft, the reinforcing arm can share part of the pressure, thereby increasing the connection strength of the folding joint of the chassis.

The present application includes at least one of the following beneficial technical effects:
1. the overall mechanical strength of the chassis is high, and it is not easy to be damaged. The reinforcing arm is fixed on the first support frame, and a reinforcement assembly is arranged below the chassis. The reinforcing arm and the reinforcement assembly can increase the load-bearing strength and folding strength of the chassis;
2. it saves space, is convenient to carry and store. Both the chassis and the reinforcement assembly can be folded in half, and the reinforcement rod has a bend to provide accommodating space. Both the frame cloth cover and the child seat can be folded, resulting in a high overall folding degree;
3. it has both storage function and riding function, with high riding comfort and high safety. A child seat is fixed in the frame cloth cover, the child seat has a backrest part, and the cushion part is suspended in the stroller. When a child rides, the back has support and the legs can bend, resulting in higher comfort. At the same time, a safety belt is provided on the child seat, and the shoulder belt of the safety belt can be adjusted to ensure that the safety belt can fit, so that the safety of the child when riding is high.

### BRIEF DESCRIPTION OF THE DRAWINGS

FIG. 1 is a schematic perspective view of a frame assembly structure of a folding stroller according to an embodiment of the present application.

FIG. 2 is a schematic perspective view of a folding stroller according to an embodiment of the present application.

FIG. 3 is a top view of a frame assembly of a folding stroller according to an embodiment of the present application.

FIG. 4 is an enlarged schematic view of position A in FIG. 1.

FIG. 5 is a schematic view of a storage state of a frame assembly of a folding stroller according to an embodiment of the present application.

FIG. 6 is a partial structural schematic view of a frame assembly of a folding stroller according to an embodiment of the present application.

FIG. 7 is another top view of the frame assembly of the folding stroller according to an embodiment of the present application.

FIG. 8 is an enlarged schematic view of position B in FIG. 6.

FIG. 9 is a folding schematic view of a frame assembly of ae folding stroller according to an embodiment of the present application.

FIG. 10 is an enlarged schematic view of position C in FIG. 6.

FIG. 11 is another schematic perspective view of a folding stroller according to an embodiment of the present application.

FIG. 12 is a schematic perspective view of a child seat of a folding stroller according to an embodiment of the present application.

FIG. 13 is a partial structural schematic view of a child seat of a folding stroller according to an embodiment of the present application.

### DETAILED DESCRIPTION OF THE INVENTION

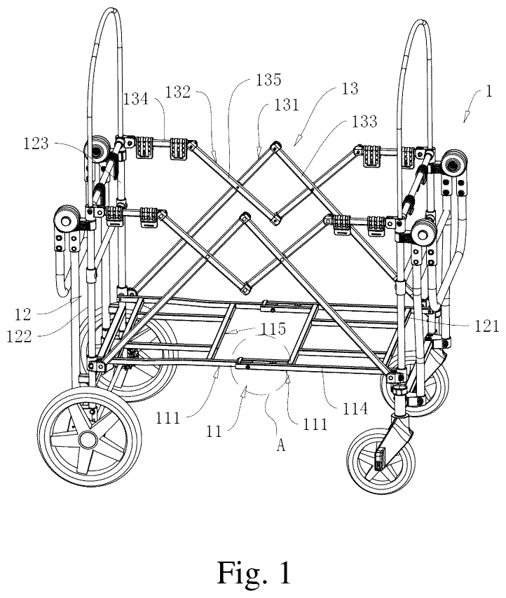

The present application will be further described in detail below with reference to FIGS. 1-13.

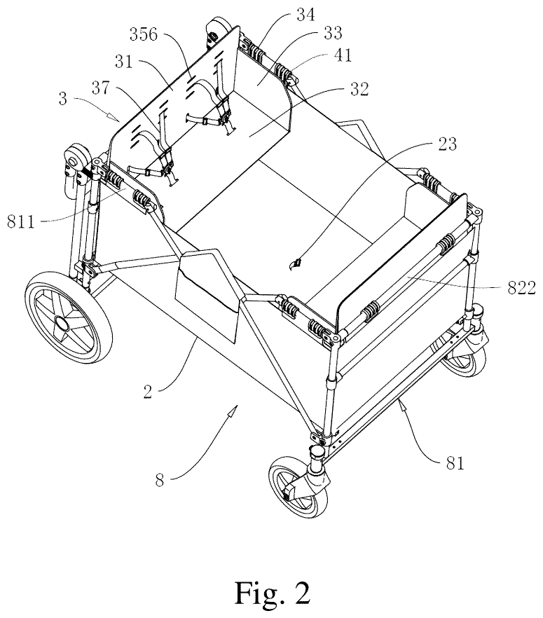

The embodiment of the present application discloses a folding stroller. Referring to FIGS. 1 and 2, the folding stroller includes a frame assembly 1, a frame cloth cover 2 and a child seat 3. The frame assembly 1 constitutes the frame structure of the folding stroller, which is used for supporting, load-bearing and having a folding function. The frame cloth cover 2 is covered on the frame assembly 1 for forming a storage space to place items. The child seat 3 is installed in the frame cloth cover 2 for children to ride. The frame assembly 1 includes a chassis 11, end frames 12 and folding side frames 13. The chassis 11 is used for load-bearing. The end frames 12 are fixed at two ends of the chassis 11, one of which is a handle end to facilitate pushing the stroller. The folding side frames 13 are fixed between the two end frames 12, and the folding side frames 13 are folded to make the two end frames 12 close to each other to realize folding.

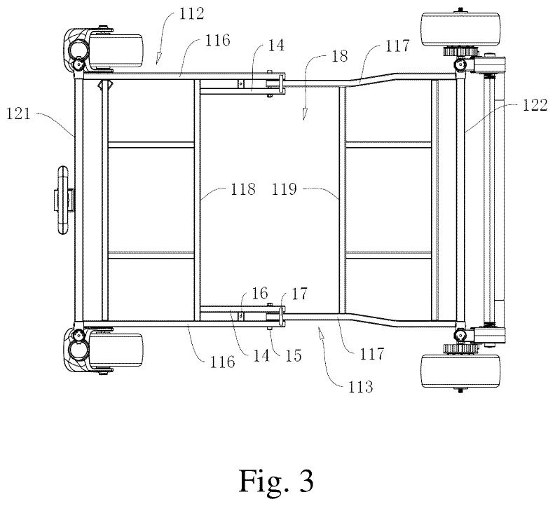

Referring to FIGS. 1 and 3, the chassis 11 includes two supporting plates 111. Taking the direction in FIG. 1 as an example, the supporting plate 111 on the right is the first supporting plate 112, and the supporting plate 111 on the left is the second supporting plate 113. Respective ends of the first supporting plate 112 and the second supporting plate 113 are rotatably connected to the two end frames 12. The end frame 12 rotatably connected to the first supporting plate 112 is the first end frame 121, and the end frame connected to the second supporting plate 113 is the second end frame 122. The first supporting plate 112 and the second supporting plate 113 are rotatably connected to each other at the other end. Each supporting plate 111 includes a pair of mutually parallel support rods 114 and a support frame 115 fixedly connected between the two support rods 114. The pair of support rods 114 on the first supporting plate 112 are first support rods 116, and the pair of support rods 114 on the second supporting plate 113 are second support rods 117; the first support rod 116 has one end rotatably connected to one end of the second support rod 117, and the other ends of the first support rod 116 and the second support rod 117 are respectively rotatably connected to the two end frames 12. The support frame 115 fixed between the two first support rods 116 is a first support frame 118, and the support frame 115 fixed between the two second support rods 117 is a second support frame 119.

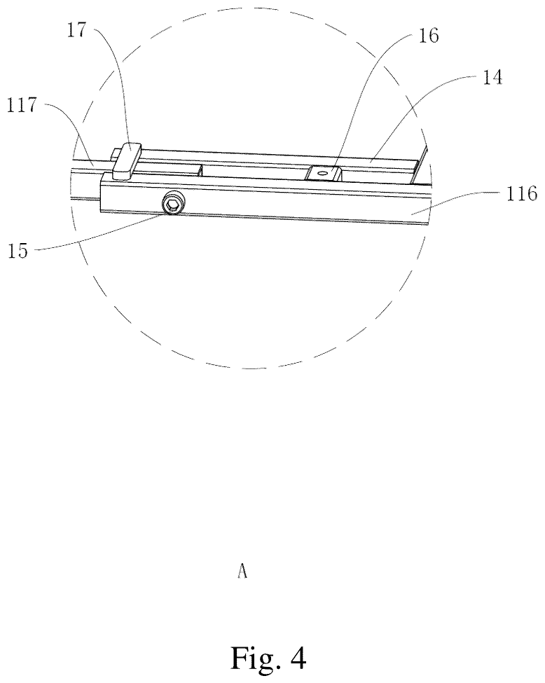

Referring to FIGS. 3 and 4, a coaxially connected reinforcing arm 14 is provided at the rotating shaft of the first support rod 116 and the second support rod 117, and preferably two reinforcing arms 14 are provided. The second support rod 117 is located between the first support rod 116 and the reinforcing arm 14, and the reinforcing arm 14 is relatively fixed to the first support rod 116 and rotates synchronously with the first support rod 116. The reinforcing arm 14 is arranged in parallel with the first support rod 116; the second support rod 117 has one end rotatably connected to both the first support rod 116 and the reinforcing arm 14, and the rotation joint of the second support rod 117 and the reinforcing arm 14 is coaxial with the rotation joint of the second support rod 117 and the first support rod 116. The reinforcing arm 14 has one end fixed on the first support frame 118 and the other end coaxially connected to the first support rod 116 and the second support rod 117, and a common rotating shaft of the reinforcing arm 14, the first support rod 116 and the second support rod 117 is a folding shaft 15. An implementation of the folding shaft 15 may be connecting the first support rod 116, the second support rod 117 and the reinforcing arm 14 through a bolt, and the bolt forms the rotating shaft of the first support rod 116, the second support rod 117 and the reinforcing arm 14. The reinforcing arm 14 is relatively fixed to the first support rod 116, and the reinforcing arm 14 rotates around the folding shaft 15 together with the first support rod 116.

A fixing block 16 is provided between the first support rod 116 and the reinforcing arm 14, and the fixing block 16 further fixedly connects the first support rod 116 and the reinforcing arm 14.

A fixing strip 17 is provided at the folding shaft 15 and further fixedly connects the first support rod 116 and the reinforcing arm 14. Specifically, the fixing strip 17 may be provided on a side of the folding shaft 15 close to the second support frame 119 and above the second support rod 117. When a joint of the first support rod 116 and the second support rod 117 is subjected to downward pressure, the parts of the first support rod 116 and the reinforcing arm 14 located on the side of the folding shaft 15 close to the second support frame 119 have a tendency to bend downward; at this time, the part of the second support rod 117 located on the side of the folding shaft 15 close to the first support frame 118 has a tendency to bend downward, while the part of the second support rod 117 located on the side of the folding shaft 15 close to the second support frame 119 has a tendency to bend upward; since the fixing strip 17 is located on the side of the folding shaft 15 close to the second support frame 119, the downward bending force of the parts of the first support rod 116 and the reinforcing arm 14 located on the side of the folding shaft 15 close to the second support frame 119 and the upward bending force of the part of the second support rod 117 located on the side of the folding shaft 15 close to the second support frame 119 cause the fixing strip 17 to press tightly against the second support rod 117, thereby restricting the joint of the first support rod 116 and the second support rod 117 from bending downward. In addition, the fixing strip 17 can also be arranged on the side of the folding shaft 15 close to the first support frame 118, and the upward bending force of the parts of the first support rod 116 and the reinforcing arm 14 located on the side of the folding shaft 15 close to the first support frame 118 and the downward bending force of the part of the second support rod 117 located on the side of the folding shaft 15 close to the first support frame 118 cause the fixing strip 17 to press tightly against the second support rod 117.

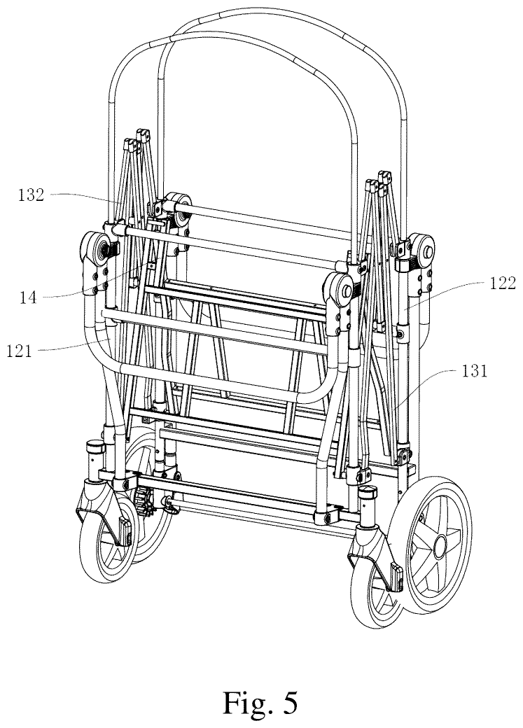

Referring to FIGS. 1 and 5, the folding side frame 13 includes a first folding rod 131 and a second folding rod 132, the end frame 12 includes a number of vertical columns 123, and the vertical columns 123 are preferably four, that is, located at the four vertices of the rectangular frame of the chassis 11, and the vertical columns 123 are provided with sleeves, which can rotate circumferentially around the vertical columns 123. Two ends of the first folding rod 131 and the second folding rod 132 are respectively rotationally connected to the vertical column 123 of the first end frame 121 and the vertical column 123 of the second end frame 122, and the first folding rod 131 and the second folding rod 132 rotate in a vertical plane where the vertical column 123 of the first end frame 121 and the vertical column 123 of the second end frame 122 are located. The first folding rod 131 has two first folding arms 133, respective ends of the two first folding arms 133 are rotationally connected, and the other ends of the two first folding arms 133 are respectively rotationally connected to the vertical column 123 of the first end frame 121 and the vertical column 123 of the second end frame 122; the second folding rod 132 includes two parallel arms 134 and two second folding arms 135, the two parallel arms 134 are arranged parallel to the first support rod 116 and are located on the same horizontal line. Respective ends of the two parallel arms 134 are respectively rotationally connected to the vertical column 123 of the first end frame 121 and the vertical column 123 of the second end frame 122, the other ends of the two parallel arms 134 are respectively rotationally connected to respective ends of the two second folding arms 135, and the other ends of the two second folding arms 135 are rotationally connected. The first folding arm 133 and the second folding arm 135 are arranged crosswise, and the crossing point of the first folding arm 133 and the second folding arm 135 is rotationally connected. The first folding arm 133 and the second folding arm 135 enclose to form a parallelogram mechanism. Obviously, two groups of the first folding rod 131 and the second folding rod 132 are provided, and the two groups of first folding rods 131 and second folding rods 132 are arranged in parallel and respectively located on two sides of the chassis 11.

The first support frame 118, the second support frame 119, the two first support rods 116 and the two second support rods 117 enclose a hollow area 18, and a foot pedal can be arranged below the hollow area 18 to increase riding comfort; when the folding stroller is used for the children to ride, the children can place their feet on the foot pedal.

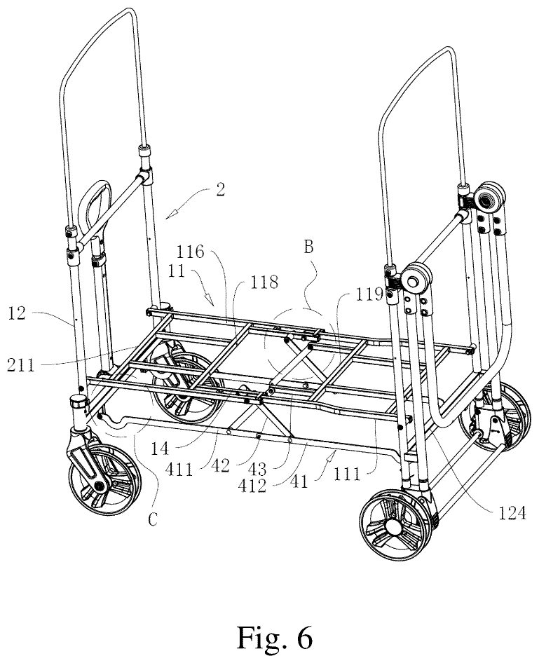

Referring to FIG. 6, in another embodiment, a reinforcement assembly 4 is further connected below the chassis 11 to improve the support for the chassis 11 and increase the overall mechanical strength, and two groups of the reinforcement assemblies 4 are preferably provided. Each group of reinforcement assembly 4 includes two reinforcement rods 41 and two cross arms 42, respective ends of the two reinforcement rods 41 in each group of reinforcement assembly 4 are respectively rotatably connected to the two end frames 12, and the other ends of the two reinforcement rods 41 in each group of reinforcement assembly 4 are rotatably connected to each other. The two cross arms 42 of each group of reinforcement assembly 4 cross each other, respective ends of the two cross arms 42 are respectively rotatably connected to the two reinforcement rods 41, and the other ends of the two cross arms 42 are respectively rotatably connected to the two supporting plates 111.

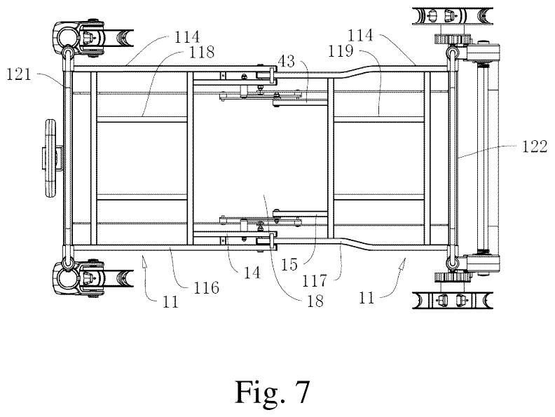

Referring to FIGS. 6 and 7, a pair of parallel connecting arms 43 are fixed on the side of the second support frame 119 facing the first support frame 118, the connecting arms 43 are parallel to the reinforcing arm 14, the connecting arm 43 has one end fixed on the second support frame 119 and the other end rotationally connected to one end of the cross arm 42. The support frame 115 includes a plurality of fixedly connected cross bars and vertical bars, the two ends of the vertical bars are fixedly connected to a pair of mutually parallel support rods 114, the reinforcing arm 14 has one end fixedly connected to the vertical bar of the first support frame 118, and the connecting arm 43 has one end fixed to the vertical bar of the second support frame 119. The number of cross bars and vertical bars is not limited, and the load-bearing capacity of the chassis 11 can be increased to a certain extent by increasing the number of cross bars and vertical bars.

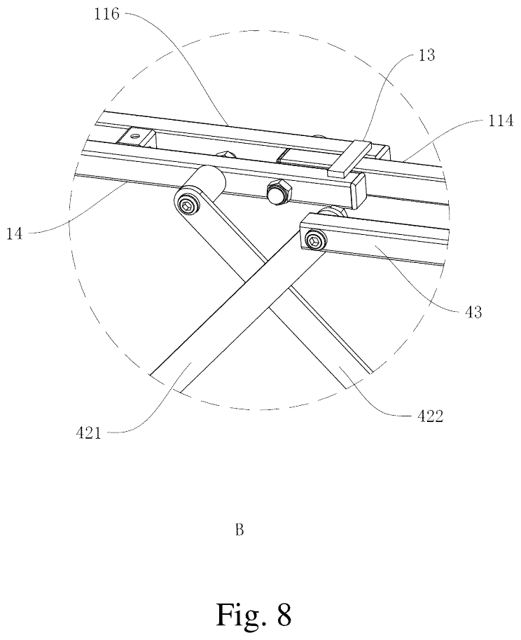

Referring to FIGS. 7 and 8, the reinforcement rod 41 rotationally connected to the first end frame 121 is a first reinforcement rod 411, the reinforcement rod 41 rotationally connected to the second end frame 122 is a second reinforcement rod 412, and one end of the first reinforcement rod 411 and one end of the second reinforcement rod 412 are rotationally connected to each other. The first reinforcement rod 411 is rotationally connected to a first cross arm 421, the second reinforcement rod 412 is rotationally connected to a second cross arm 422, and the first cross arm 421 and the second cross arm 422 cross each other. The first cross arm 421 has one end rotationally connected to the first reinforcement rod 411 and the other end rotationally connected to one end of the connecting arm 43, the second cross arm 422 has one end rotationally connected to the second reinforcement rod 412 and the other end rotationally connected to one end of the reinforcing arm 14.

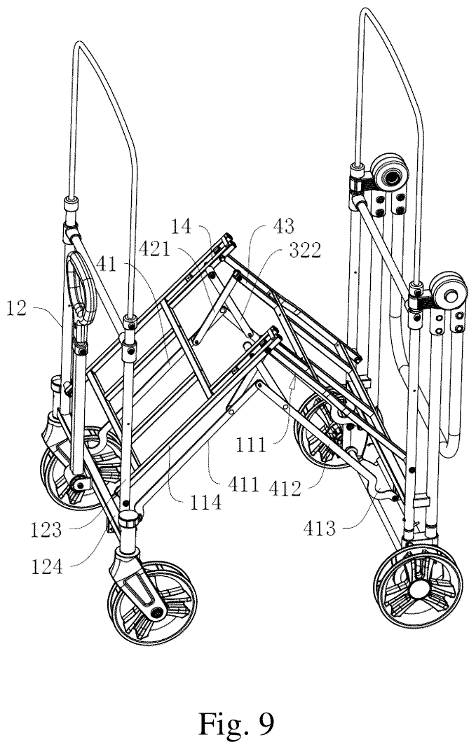

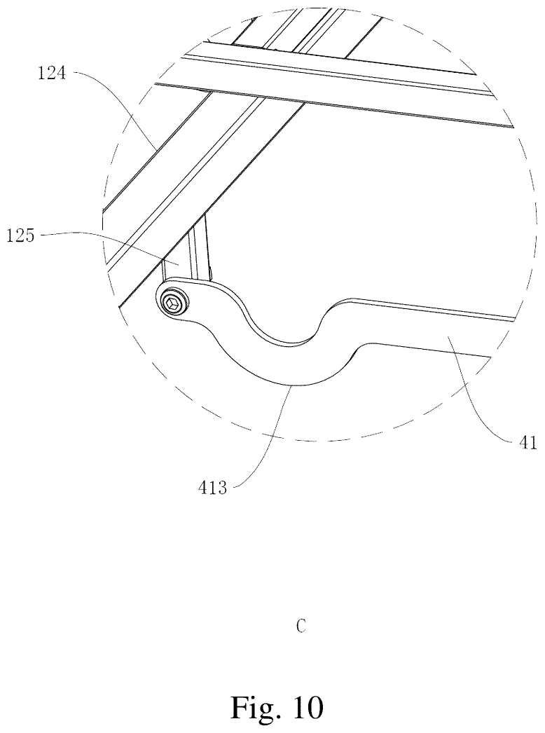

Referring to FIG. 9 and FIG. 10, the end frame 12 further includes a plurality of cross columns, the support rod 114 has one end fixed on the vertical column 123, each of the two end frames 12 has at least one cross column located below the supporting plate 111, the cross column located below the supporting plate 111 is a first cross column 124, the first cross column 124 vertically extends toward the ground with a connecting column 125, the connecting column 125 has one end fixed on the first cross column 124, and the reinforcement rod 41 has one end rotationally connected to the connecting column 125.

The reinforcement rod 41 has one end provided with a bend 413 close to the connecting column 125; when folded, the bend 413 of the reinforcement rod 41 provides an accommodating space for the first cross column 124, and the bend 413 of the reinforcement rod 41 reduces the restriction of the first cross column 124 on the folding of the reinforcement rod 41, which can facilitate the folding and storage of the reinforcement rod 41.

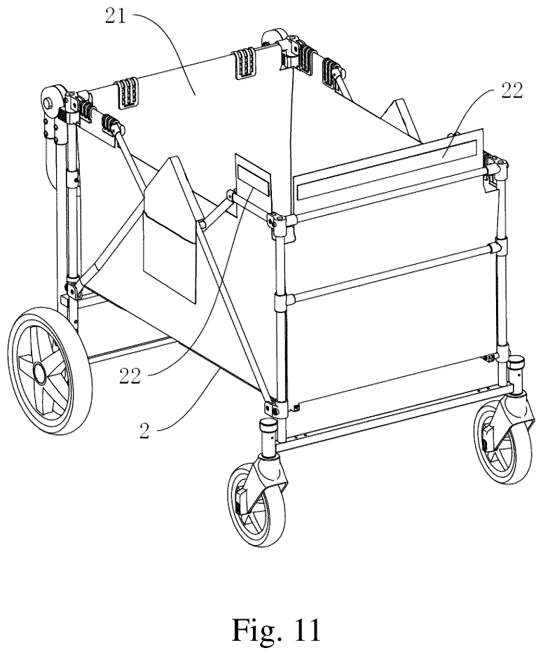

Referring to FIGS. 1 and 11, the frame cloth cover 2 is detachably mounted on the frame assembly 1 of the stroller; in one embodiment, the frame cloth cover 2 can be fixed on the frame assembly 1 in the form of Velcro. Specifically, the frame cloth cover 2 includes a main body portion 21 and an adhesive portion 22, the main body portion 21 is embedded in the inner side of the frame of the frame assembly 1 to form a storage cavity of the stroller, and the adhesive portion 22 is sewn on the edge of the main body portion 21 for relatively fixing the main body portion 21 on the frame assembly 1. A hook surface of Velcro is sewn on the outer edge of the main body portion 21, a loop surface of Velcro is sewn on the outer side of the adhesive portion 22, and the adhesive portion 22 is wound around the cross bar of the frame assembly 1 to make the hook surface adhere to the loop surface, so that the entire frame cloth cover 2 is relatively fixed on the frame assembly 1. A handle 23 is further sewn on the central bottom of the frame cloth cover 2; by pulling the frame cloth cover 2 through the handle 23, the bottom of the frame cloth cover 2 is folded in half to drive the bottom frame of the frame assembly 1 to bend, so that the two ends of the frame assembly 1 approach each other for folding, thereby realizing synchronous folding and storage of the frame cloth cover 2 and the frame assembly 1.

Referring to FIG. 2, the child seat 3 includes a backrest 31, a seat cushion 32 and side wings 33, the backrest 31 and the seat cushion 32 are flexibly hinged, the backrest 31 and the seat cushion 32 have rigid plates inside to form a rigid support structure of the child seat 3, the seat cushion 32 is used for children to sit on, the backrest 31 is used for children to lean on when sitting, the side wings 33 are located on two sides of the seat cushion 32 and connect the backrest 31 and the seat cushion 32 at the same time, fixing members 34 are fixed on the side wings 33 and the backrest 31, and by detachably connecting the fixing members 34 to the side frame of the stroller, the child seat 3 is detachably fixed in the stroller. Moreover, when the child seat 3 is fixed in the stroller, there is a certain distance between the cushion 32 and the bottom frame of the stroller, so that the child's legs can bend when sitting on the cushion 32.

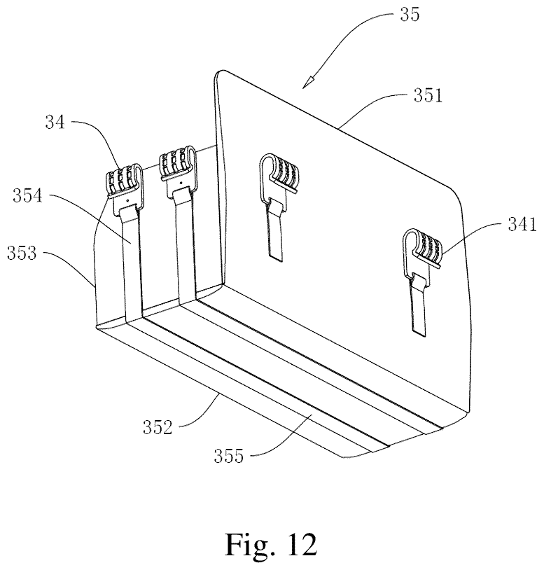

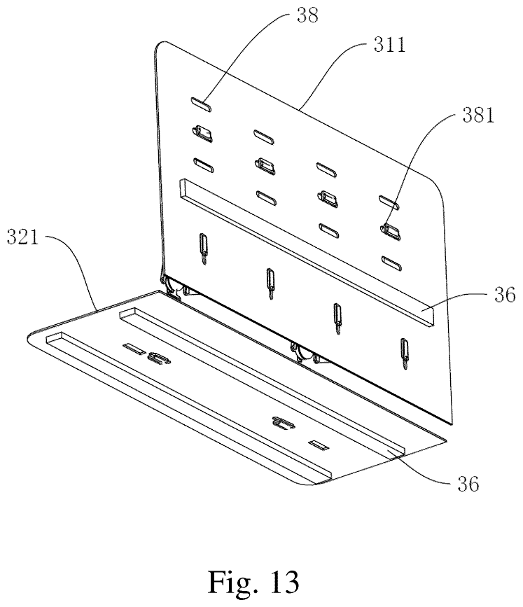

Referring to FIGS. 12 and 13, the rigid plate for rigid support in the backrest 31 is a backboard 311, and the rigid plate for rigid support in the cushion 32 is a bottom board 321. The backboard 311 and the bottom board 321 are two independent rigid plates. A seat cloth cover 35 is sewn outside the backboard 311 and the bottom board 321. The seat cloth cover 35 wraps and is sewn on the outer surfaces of the backboard 311 and the bottom board 321 and covers the connection area between them, so as to realize flexible articulation of the backboard 311 and the bottom board 321. Reinforcing ribs 36 are fixed on the backboard 311 and the bottom board 321 in the horizontal direction. The reinforcing ribs 36 are used to enhance the structural strength of the backboard 311 and the bottom board 321. The reinforcing ribs 36 are fixed on the side of the backboard 311 away from the bottom board 321 and the side of the bottom board 321 away from the backboard 311. Specifically, the reinforcing ribs 36 can be fixed on the backboard 311 and the bottom board 321 by means of screw connection.

The seat cloth cover 35 includes a backrest part 351, a cushion part 352 and a side blocking part 353. The backboard 311 is located in an interlayer of the backrest part 351, and the bottom board 321 is located in an interlayer of the cushion part 352. The cushion part 352 and the bottom board 321 form the cushion 32 to support the child to sit, and the backrest part 351 and the backboard 311 form the backrest 31 for the child to lean on. The side blocking part 353 is used to form the side wing 33. The upper end of the side blocking part 353 is connected to the side edge of the backrest part 351, and the lower end of the side blocking part 353 is connected to the side edge of the cushion part 352. The side blocking part 353 connects the backrest part 351 and the cushion part 352 at the same time, so that the backrest 31, the cushion 32 and the side wing 33 form a stable triangular structure. The three together construct a stable enclosed seating space, further improving the safety of the child's ride. At the same time, the flexibility of the cloth cover of the side blocking part 353 enables the backrest 31 and the cushion 32 to be folded, thereby also facilitating the storage of the child seat 3. When the fixing member 34 on the side blocking part 353 is fixed to the side frame of the stroller, the cushion part 352 is suspended in the cavity of the stroller, and the space formed between the cushion part 352 and the bottom of the stroller can be used to load items, thereby improving the space utilization rate in the stroller.

As a preferred embodiment, the fixing member 34 is a buckle 341. A webbing is fixed on the buckle 341. After the end of the webbing passes through the notch of the buckle 341, the end of the webbing is folded back, and then the end of the webbing is sewn to form a closed loop structure. The buckle 341 is sleeved in the closed loop formed by the webbing, and the entire webbing is sewn on the seat cloth cover 35, so that the buckle 341 is fixed on the seat cloth cover 35. The buckle 341 utilizes the elasticity of the plastic part to form an interference fit with the cross column and the parallel arm 134 to achieve locking, so as to fix and install the child seat 3 in the frame cloth cover 2. The design of the buckle 341 makes the child seat 3 easy to install and disassemble.

In another embodiment, the fixing member 34 can be in the form of Velcro, and the seat cloth cover 35 is installed on the cross bar of the stroller's side frame by wrapping and pasting. Obviously, the connection strength of this method is weaker, so the present application preferably adopts the connection method of the buckle 341.

The webbing connected to the buckle 341 located on the side blocking part 353 is the first fixing belt 354. The first fixing belt 354 extends vertically from the upper end of the side blocking part 353 to the lower end of the side blocking part 353. A second fixing belt 355 is connected between the first fixing belts 354 on the two side blocking parts 353. The two ends of the second fixing belt 355 are respectively integrally connected with respective ends of the two first fixing belts 354 in the length direction of the cushion part 352. Preferably, two support webbings formed by integrally connecting the first fixing belt 354 and the second fixing belt 355 are arranged in parallel, and the two webbings strengthen the support for the bottom board 321 and improve the structural stability of the child seat 3.

Referring to FIGS. 2 and 13, the child seat 3 further includes a safety belt 37, and the webbing ends of the safety belt 37 are respectively fixed on the backboard 311 and the bottom board 321. Specifically, the backboard 311 and the bottom board 321 are provided with mounting holes 38 for the webbing ends of the safety belt 37 to pass through; correspondingly, a side of the backrest part 351 facing the cushion part 352 and a side of the cushion part 352 facing the backrest part 351 are provided with relief holes 356 for the webbing of the safety belt 37 to pass through, and the webbing ends of the safety belt 37 are fixed on the backboard 311 and the bottom board 321 after sequentially passing through the relief holes 356 and the mounting holes 38. The safety belt 37 is preferably a five-point safety belt 37, the shoulder belt ends and waist belt ends of the safety belt 37 are fixed on the backboard 311, and the crotch belt end of the safety belt 37 is fixed on the bottom board 321. The mounting hole 38 through which the shoulder belt end of the safety belt 37 passes is the first hole position 381, and a plurality of first hole positions 381 are arranged at intervals in the vertical direction; the plurality of first hole positions 381 form different gears for shoulder adjustment, which can meet the adjustment needs of children of different heights.

According to the above-mentioned embodiment of the present invention, the frame cloth cover 2 and the child seat 3 enable the stroller to have both a storage space and a function for children to ride. The reinforcing arm 14 and the reinforcement assembly 4 arranged on the chassis 11 enhance the load-bearing capacity of the stroller to provide the structural strength of the frame assembly 1 required for storage and riding. Meanwhile, the folding side frame 13, the frame cloth cover 2 and the child seat 3 can all be folded, so that the stroller as a whole has the functions of being portable and easy to store.

The above are all preferred embodiments of the present application, and are not intended to limit the protection scope of the present application; therefore, all equivalent changes made according to the structure, shape and principle of the present application shall be covered within the protection scope of the present application.

The invention claimed is:

1. A folding stroller, comprising a chassis and end frames located at two ends of the chassis, the two end frames being a first end frame and a second end frame respectively, wherein the chassis comprises:
a first support rod provided in two, each having one end rotatably connected to the first end frame;
a second support rod provided in two, each having one end rotatably connected to the second end frame;
a first support frame fixed between the two first support rods;
a second support frame fixed between the two second support rods; and
a reinforcing arm having one end fixed on the first support frame, the second support rod having one end rotatably connected to both the first support rod and the reinforcing arm, a rotation joint between the second support rod and the reinforcing arm being coaxial with a rotation joint between the second support rod and the first support rod, and the second support rod being located between the first support rod and the reinforcing arm.

2. The folding stroller according to claim 1, wherein a first folding rod and a second folding rod are provided between the first end frame and the second end frame, the first folding rod has two first folding arms, respective ends of the two folding arms of the first folding rod are rotatably connected, the other ends of the two folding arms of the first folding rod are respectively rotatably connected to the first end frame and the second end frame, the second folding rod comprises two parallel arms and two folding arms, respective ends of the two parallel arms of the second folding rod are respectively rotatably connected to the first end frame and the second end frame, the other ends of the two parallel arms of the second folding rod are respectively rotatably connected to the respective ends of the two folding arms of the second folding rod, the other ends of the two folding arms of the second folding rod are rotatably connected, the folding arms of the first folding rod and the folding arms of the second folding rod are arranged to cross, and a crossing point of the folding arms of the first folding rod and the folding arms of the second folding rod is rotatably connected.

3. The folding stroller according to claim 1, wherein two sets of reinforcement assemblies are connected to the chassis, each reinforcement assembly comprises two reinforcement rods and two cross arms, the reinforcement rods are located below the chassis, respective ends of the two reinforcement rods are rotatably connected to the two end frames respectively, the other ends of the two reinforcement rods are rotatably connected to each other, the two cross arms cross each other, respective ends of the two cross arms are rotatably connected to the two reinforcement rods respectively, and the other ends of the two cross arms are rotatably connected to the two chassis respectively.

4. The folding stroller according to claim 1, wherein a fixing strip is provided at the rotating shaft of the first support rod and the reinforcing arm, the fixing strip restricts downward bending at a joint of the first support rod and the second support rod, and the fixing strip is fixedly connected to the first support rod and the reinforcing arm.

5. The folding stroller according to claim 1, wherein a fixing block is provided between the first support rod and the reinforcing arm, and the fixing block is fixedly connected to the first support rod and the reinforcing arm.

6. The folding stroller according to claim 1, wherein the first support frame comprises a plurality of cross bars and vertical bars, the cross bars are fixedly connected between the vertical bars, the vertical bars are fixedly connected to the first support rod, and the reinforcing arm is fixedly connected to the vertical bars.

7. The folding stroller according to claim 1, wherein the first support frame, the second support frame, the two first support rods and the two second support rods enclose a hollow area.

8. The folding stroller according to claim 3, wherein a pair of parallel connecting arms are fixed on the side of the second support frame facing the joint of the two chassis, the connecting arms are parallel to the reinforcing arms, and respective ends of the two cross arms of each reinforcement assembly are rotatably connected to one reinforcing arm and one connecting arm respectively.

9. The folding stroller according to claim 3, wherein each end frame comprises a plurality of fixedly connected cross columns and vertical columns, one cross column is fixed below the chassis, the cross column located below the chassis extends towards the ground with a connecting column, the connecting column has one end fixed on the cross column below the chassis, and the reinforcement rod has one end rotatably connected to the connecting column.

10. The folding stroller according to claim 9, wherein the reinforcement rod has one end provided with a bend close to the connecting column, and the bend of the reinforcement rod provides an accommodation space for a cross column below the chassis assembly when folded.

11. The folding stroller according to claim 1, further comprising a frame cloth cover, which covers and is detachably fixed on the frame of the stroller.

12. The folding stroller according to claim 11, wherein a handle is sewn at a center of a bottom of the frame cloth cover, and the handle is used to lift the frame cloth cover to facilitate folding the frame.

13. The folding stroller according to claim 1, furthering comprising a child seat, wherein the child seat comprises a backboard, a bottom board and a seat cloth cover, the backboard and the bottom board are located in an interlayer of the seat cloth cover to form support, the seat cloth cover comprises a backrest part, a cushion part and side blocking parts, the backrest part is sheathed outside the backboard, the cushion part is sheathed outside the bottom board, the side blocking parts are arranged on two sides of the cushion part and connect the backrest part and the cushion part, upper ends of the two side blocking parts and the back side of the backrest part are provided with fixing members, the fixing members are used to detachably fix the seat cloth cover on the side frame of the stroller, and when the seat cloth cover is fixed on the side frame of the stroller, the cushion part is suspended in an inner cavity of the stroller.

14. The child seat of the folding stroller according to claim 13, further comprising a safety belt, wherein the backboard and the bottom board are provided with mounting holes for webbing ends of the safety belt to pass through, the webbing ends of the safety belt pass through the mounting holes and are respectively fixed on the backboard and the bottom board, and relief holes for webbing of the safety belt to pass through are provided at a side of the backrest part facing the cushion part and a side of the cushion part facing the backrest part.

15. The child seat of the folding stroller according to claim 14, wherein the mounting hole for the end of the shoulder belt of the safety belt to pass through is a first hole position, and the plurality of first hole positions are arranged at intervals in the vertical direction.

16. The child seat of the folding stroller according to claim 14, wherein the safety belt is a five-point safety belt, ends of the shoulder belts and waist belts of the safety belt are fixed on the backboard, and ends of the crotch belts of the safety belt are fixed on the bottom board.

17. The child seat of the folding stroller according to claim 13, wherein reinforcing ribs are horizontally fixed on the backboard and the bottom board, and the reinforcing ribs are fixed on a side of the backboard facing away from the bottom board and a side of the bottom board facing away from the backboard.

18. The child seat of the folding stroller according to claim 13, wherein the fixing member is a buckle, a webbing is fixed on the buckle and sewn on the seat cloth cover.

19. The child seat of the folding stroller according to claim 18, wherein the webbing connected to the buckle on the side blocking part is a first fixing belt, the first fixing belt extends vertically from an upper end of a side blocking part to a lower end of the side blocking part, a second fixing belt is connected between the first fixing belts on the two side blocking parts, and two ends of the second fixing belt are respectively integrally connected with respective ends of the two first fixing belts in the length direction of the cushion part.
